(19) United States
(12) Patent Application Publication
(10) Pub. No.: US 2006/0050050 A1
(43) Pub. Date: Mar. 9, 2006

(54) Driving a bi-stable matrix display device

(76) Inventors: Guofu Zhou, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/543,202

(22) PCT Filed: Jan. 13, 2004
(86) PCT No.: PCT/IB04/50012

§ 371 Date: Jul. 22, 2005

(30) Foreign Application Priority Data
Jan. 23, 2003 (EP) 03100133.2
Jul. 14, 2003 (EP) 03102135.5
Aug. 1, 2003 (EP) 03102403.7

(51) Int. Cl. G09G 3/34

(52) U.S. Cl. 345/107

(57) ABSTRACT

A bi-stable display (100) is driven by supplying (101) voltage waveforms to pixels (18) of the display (100). It is determined (150), based on information to be displayed (DI) on the display (100) during an image update period (IUP), which pixels (18) have to change their optical state during the image update period (IUP). A sub-area of pixels (WI) is determined (151) which has to be updated during this image update period (IUP). The dimensions of the sub-area (W1) are dynamically determined to cover the pixels (18) which have to change their optical state during this image update period (IUP). The drive circuit (101) is controlled (152) to only address the pixels (18) of the sub-area (WI).

### FIELD OF THE INVENTION

The invention relates to a drive circuit for driving a bi-stable display device, to a display apparatus comprising a bi-stable display device and such a drive circuit, and to a method of driving a bi-stable display device.

Bi-stable display devices, such as, for example, electrophoretic matrix displays are used in, for example, electronic books, mobile telephones, personal digital assistants, laptop computers, and monitors.

### BACKGROUND OF THE INVENTION

An electrophoretic display device is known from international patent application WO 99/53373. This patent application discloses an electronic ink display which comprises two substrates, one of which is transparent, the other substrate is provided with electrodes arranged in rows and columns. Display elements or pixels are associated with intersections of the row and column electrodes. Each display element is coupled to the column electrode via a main electrode of a thin-film transistor (further referred to as TFT). A gate of the TFT is coupled to the row electrode. This arrangement of display elements, TFT's and row and column electrodes jointly forms an active matrix display device.

Each pixel comprises a pixel electrode which is the electrode of the pixel which is connected via the TFT to the column electrodes. During an image update period or image refresh period, a row driver is controlled to select all the rows of display elements one by one, and the column driver is controlled to supply data signals in parallel to the selected row of display elements via the column electrodes and the TFT's. The data signals correspond to image data to be displayed.

Furthermore, an electronic ink is provided between the pixel electrode and a common electrode provided on the transparent substrate. The electronic ink is thus sandwiched between the common electrode and the pixel electrodes. The electronic ink comprises multiple microcapsules of about 10 to 50 microns. Each microcapsule comprises positively charged white particles and negatively charged black particles suspended in a fluid. When a positive voltage is applied to the pixel electrode with respect to the common electrode, the white particles move to the side of the microcapsule directed to the transparent substrate, and the display element appears white to a viewer. Simultaneously, the black particles move to the pixel electrode at the opposite side of the microcapsule where they are hidden from the viewer. By applying a negative voltage to the pixel electrode with respect to the common electrode, the black particles move to the common electrode at the side of the microcapsule directed to the transparent substrate, and the display element appears dark to a viewer. When the electric field is removed, the display device remains in the acquired state and exhibits a bi-stable character. This electronic ink display with its black and white particles is particularly useful as an electronic book.

Grey scales can be created in the display device by controlling the amount of particles that move to the common electrode at the top of the microcapsules. For example, the energy of the positive or negative electric field, defined as the product of field strength and time of application, controls the amount of particles which move to the top of the microcapsules.

From the non-pre-published European patent application EP03100133.2 it is known to minimize the image retention by extending the duration of the reset pulse which is applied before the drive pulse. An over-reset pulse is added to the reset pulse, the over-reset pulse and the reset pulse together, have an energy which is larger than required to bring the pixel into one of two extreme optical states. The duration of the over-reset pulse may depend on the required transition between successive optical states of a pixel. Unless explicitly mentioned, for the sake of simplicity, the term reset pulse may cover both the reset pulse without the over-reset pulse or the combination of the reset pulse and the over-reset pulse. By using the reset pulse, the pixels are first brought into one of two well defined extreme optical states before the drive pulse changes the optical state of the pixel in accordance with the image to be displayed. This improves the accuracy state of the grey or intermediate levels.

For example, if black and white particles are used, the two extreme optical states are black and white. In the extreme state black, the black particles are at a position near to the transparent substrate, in the extreme state white, the white particles are at a position near to the transparent substrate.

The drive pulse has an energy to change the optical state of the pixel to a desired level which may be in-between the two extreme optical states. Also the duration of the drive pulse may depend on the required transition of the optical state.

The non-prepublished patent application EP03100133.2 discloses in an embodiment that preset pulses (also referred to as the shaking pulse) precedes the reset pulse. Preferably, the shaking pulse comprises a series of AC-pulses (the preset pulses), however, the shaking pulse may comprise a single preset pulse only. Each level (which is one preset pulse) of the shaking pulse has an energy (or a duration if the voltage level is fixed) sufficient to release particles present in one of the extreme positions, but insufficient to enable said particles to reach the other one of the extreme positions. The shaking pulse increases the mobility of the particles such that the reset pulse has an immediate effect. If the shaking pulse comprises more than one preset pulse, each preset pulse has the duration of a level of the shaking pulse. For example, if the shaking pulse has successively a high level, a low level and a high level, this shaking pulse comprises three preset pulses. If the shaking pulse has a single level, only one preset pulse is present.

The non-prepublished European patent application EP02077017.8 is directed to the use of shaking pulses directly preceding the drive pulses.

The complete voltage waveform which has to be presented to a pixel during an image update period is referred to as the drive waveform. The drive waveform usually differs for different optical transitions of the pixels.

In all embodiments, during each image update period a drive waveform is supplied which comprises the same sequence, for example: a reset pulse preceding a drive pulse, or a shaking pulse, a reset pulse and a drive pulse, or a shaking pulse, a reset pulse, a shaking pulse and a drive pulse. As different pixels may have to change to different optical states, and each pixel may change from any optical state to any optical state, the duration of each image update period is determined by the duration of the longest drive waveform.

### SUMMARY OF THE INVENTION

The driving of the bi-stable display device in accordance with the present invention differs from the driving disclosed in the non-prepublished patent application EP03100133.2 in that the display has a display mode wherein only a sub-area of the complete display area of the display is updated. The dimensions of this sub-area are dynamically determined, for example for each image update period. The dimensions of the sub-area depend on which pixels have to change their optical state during a next image update period. Only the pixels which belong to the sub-area are updated during the image update period. This has the advantage that the image update period will be very short if only a few pixels need to be updated and thus the sub-area is small. If more pixels have to be updated in another image update period, the sub-area will be selected larger to cover at least the pixels which should be updated, and the image update period will become somewhat longer. Consequently, dependent on the number of pixels which have to be updated, the dimensions of the sub-area are controlled dynamically to cover the pixels which have to be updated.

The shorter image update period or the higher refresh rate in the sub-area is important if the information displayed in the sub-area changes at high rate. An example of an application is a display apparatus which is able to show a relatively slowly changing image in a background area and which displays text information in the sub-area (a window overlaying the background area) which should be updated relatively fast in response to user input. As the amount of user input and/or the display of information in response to the information inputted may vary, it is advantageous to keep track of the dimensions of the sub-area(s) to only update the required sub-area of pixels.

A first aspect of the invention provides a drive circuit for driving a bi-stable display as claimed in claim 1. A second aspect of the invention provides a display apparatus as claimed is claim 16. A third aspect of the invention provides a method as claimed in claim 19. Advantageous embodiments are defined in the dependent claims.

In an embodiment in accordance with the invention as defined in claim 2, the controller further comprises a circuit for determining (150) which pixels (18) have to change their optical state during the image update period (IUP). By way of example, this circuit may comprise a memory to store a previous image and compares which pixels have to change their optical state in the next image.

In an embodiment in accordance with the invention as defined in claim 3, the matrix display comprises intersecting select electrodes and data electrodes, the pixels are associated with intersections of the select electrodes and the data electrodes. The controller controls the select driver to supply select voltages to the select electrodes to select lines of pixels associated with the sub-area only, and the data driver to supply the data voltages or drive waveforms to the data electrodes. The data voltages supplied to pixels not belonging to the sub-area have a level such that the optical state of these pixels, which are selected also, does not change.

Thus, the sub-area may be addressed in the same manner as usually a complete display would be addressed. The difference is that only the select lines associated with the pixels of the sub-area are addressed, and that the data voltages supplied to the pixels outside the sub-area are selected to prevent that the optical state of these pixels changes.

It should be noted that it is possible that the sub-area is composed of several sub-areas which form non-overlapping areas. For example, the sub-area comprises a first window in which the user is able to input characters, and a second window in which a list of words is shown which start with the input characters.

In an embodiment in accordance with the invention as defined in claim 4, the address controller also supplies the hold-voltage to pixels within the sub-area which do not have to change their optical state. This implicitly means that the pixels within the sub-area have to be addressable separately to be able to supply drive waveforms for changing the optical state of pixels which have to change their optical state, and to be able to supply the hold-voltage to the pixels which should not change their optical state.

In an embodiment in accordance with the invention as defined in claim 5, the sub-area comprises a rectangular window, and the controller controls the select driver to select, during an image update period, only the lines of pixels of the rectangular window. These lines of pixels form a consecutive group.

In an embodiment in accordance with the invention as defined in claim 6, the controller receives at least coordinates of two opposite corners of the rectangular window. The controller determines from the coordinates, the select electrodes and the data electrodes which are associated with the sub-area.

In an embodiment in accordance with the invention as defined in claim 7, the controller determines the minimal possible dimensions of the sub-area based on the pixels which have to change their optical state during a particular image update period. This allows obtaining the highest possible refresh rate for every image update period.

Alternatively, it is possible to define minimal dimension of the sub-area. Now, the sub-area is only enlarged if is detected that during a particular image update period pixels positioned outside but near to the sub-area have to change their optical states. Further, it is possible to check during a predetermined period in time, for example 20 milliseconds, which pixels have to change their optical state and to provide an image update period with a minimal duration by only updating the, preferably rectangular, sub-area just covering these pixels.

In an embodiment in accordance with the invention as defined in claim 8, the select driver selects the lines of pixels associated with the select electrodes one by one, in the same manner as usually the complete display is addressed.

The one by one selection of the select electrodes allows supplying different drive waveforms to different pixels. This allows providing a hold voltage to the pixels within the sub-area which do not have to change their optical state. If the aligned shaking is used as will be elucidated with respect to claim 9, the shaking pulses are supplied to all the pixels within the sub-area, thus even to the pixels which should not change their optical state. If the select electrodes are selected one by one it is possible to supply no shaking pulse at all to the pixels which should not change their optical state.

In an embodiment in accordance with the invention as defined in claim 9, the drive circuit drives an electrophoretic display. Such an electrophoretic display may comprise microcapsules which contain at least two types of different particles. The different particles have different optical properties and are charged differently. The drive circuit is arranged to generate, during image update periods, a shaking pulse which precedes a drive pulse. The use of a shaking pulse is disclosed in the non-prepublished patent application EP03100133.2. The shaking pulse comprises at least one preset pulse which has an energy sufficient to release the particles present in one of the two extreme positions corresponding to one of the extreme optical states but insufficient to enable the particles to reach the other one of the two extreme positions corresponding the other one of the extreme optical states. The drive pulse determines the intermediate optical state of the pixel. The use of the shaking pulse improves the intermediate level reproduction.

The shaking pulses are aligned in time such that they occur for all pixels of the sub-area during the same period of time, or said differently, during the shaking pulses, all the pixels of the sub-area receive the same voltage levels during the same periods of time. These aligned shaking pulses allow selecting more than one line of pixels associated with more than one select electrode at the same time. During the shaking pulse, it is possible to select all the select electrodes associated with the sub-area at the same time, this significantly decreases the duration of the image update period and thus significantly shortens the image refresh rate. It is also possible to select sub-groups of these select electrodes at the same time, this still provides a higher refresh rate and lowers the power consumption because parasitic capacitances will have less influence. A minimal peak power consumption is reached if these select electrodes are still selected one by one. During the drive period when the drive voltages are supplied to the pixels of the sub-area, the select electrodes associated with the sub-area have to be selected one by one because the drive voltages may differ for different pixels.

It has to be noted that in this driving scheme, the shaking pulses are supplied to every pixel within the sub-area. If it is desired to provide a hold voltage to the pixels of the sub-area which should not change their optical state, the select electrodes should be selected one by one to allow to supply the hold pixels to the selected pixels which should not change their optical state, and to supply the complex drive waveforms with shaking pulses to the pixels which should change their optical state.

In an embodiment in accordance with the invention as defined in claim 10, the controller controls in the first display mode, the drive circuit to only update the pixels of the sub-area. The select driver only selects lines of pixels corresponding to the sub-area. The controller controls in the second display mode, the drive circuit to update a second area which is the complete display area or the area outside the sub-area. The select driver selects the lines of pixels corresponding to the complete display area or to the area outside the sub-area.

Consequently, because for the sub-area only a subset of the select electrodes has to be selected, the first image update period of the sub-area will be shorter than the second image update period of the second area. Consequently, the refresh rate of the sub-area is higher than the refresh rate of the second area.

In an embodiment in accordance with the invention as defined in claim 11, if the complete display or the pixels outside the sub-area only are updated, the pixels are addressed one by one. This has the advantage that pixels which should not change their optical state only receive a hold voltage. No drive waveforms need to be supplied to these pixels. Even if in an electrophoretic display drive scheme aligned shaking pulses are used, still the pixels are line by line to allow each pixel to receive its individual data voltage.

In an embodiment in accordance with the invention as defined in claim 12, the drive circuit drives an electrophoretic display which comprises microcapsules containing at least two types of different particles. The different particles have different optical properties and are charged differently. The drive circuit is arranged for generating, during the further image update periods, a shaking pulse which precedes a drive pulse. The use of a shaking pulse is disclosed in the non-prepublished patent application EP03100133.2. The shaking pulses are aligned in time such that they occur, during the second display mode, for all pixels of the complete display area, or the area outside the sub-area (both further referred to as the second area) during the same period of time. These aligned shaking pulses allow selecting more than one line of pixels associated with more than one select electrode at the same time. During the shaking pulse, it is possible to select all the select electrodes associated with the second area at the same time, this significantly decreases the duration of the further image update period and thus significantly shortens the image refresh rate. It is also possible to select sub-groups of these select electrodes at the same time, this still provides a higher refresh rate and lowers the power consumption because parasitic capacitances will have less influence. A minimal peak power consumption is reached if these select electrodes are still selected one by one. During the drive period when the drive voltages are supplied to the pixels of the second area, the select electrodes associated with the second area have to be selected one by one because the drive voltages may differ for different pixels.

In an embodiment in accordance with the invention as defined in claim 13, in the first display mode, only the information in sub-area of the display screen has to be updated. In the second display mode, the information in a second area which is the complete display area of the display, or the area outside the sub-area has to be updated. The dimensions of the sub-area are controlled to cover only a sub-portion of the display where the information has to be refreshed during an image update period. In this manner, the refresh rate of the information in the sub-area is increased. By further using during the first display modes optical state transitions which require shorter image update periods than the optical state transitions in the second area, the refresh rate becomes even higher. The duration of an image update period is determined by the drive waveform required to obtain a particular optical transition.

It is thus possible to refresh the information in the sub-area at a relatively high rate compared to refreshing the information in the second area. The higher refresh rate in the first area may be important if the information displayed in the first area changes at a higher rate than the refresh rate possible for the second area or the complete display. An example of an application is a display apparatus which is able to show a relatively slowly changing image in the second area (the background area) and which displays text information in the first area (a window overlaying the background area) which should be updated relatively fast in response to user input.

It should be noted that it is possible that the sub-area is composed of several sub-areas which form non-overlapping areas. For example, the sub-area comprises a first window in which the user is able to input characters, and a second window in which a list of words is shown which start with the input characters.

In an embodiment in accordance with the invention as defined in claim 14, in the sub-area the information is displayed by using only the two extreme optical states. The two extreme optical states can be obtained accurately with relatively short drive waveforms which may contain a reset pulse only. The image update period is relatively short and a relatively high refresh rate is possible.

In an embodiment in accordance with the invention as defined in claim 15, in the second area information is displayed which is allowed to obtain optical states in-between the extreme optical states. Now, a drive pulse which determines the intermediate level starting from one of the extreme optical states is required. Thus, the image update time required for the addressing of the second area is relatively long.

Preferably, in the second area information is displayed which is allowed to obtain anyone of the possible optical states available for the display, and thus the second image update period must have the maximum duration.

These and other aspects of the invention are apparent from and will be elucidated with reference to the embodiments described hereinafter.

### BRIEF DESCRIPTION OF THE DRAWINGS

In the drawings:

FIG. 1 shows schematically a display apparatus with a driver and a bi-stable display,

FIG. 2 shows different areas on the display screen,

FIG. 3 shows drive voltages used for updating a complete area of the display screen or the sub-area on the display screen in accordance with an embodiment of the invention,

FIG. 4 shows diagrammatically a cross-section of a portion of an electrophoretic display,

FIG. 5 shows diagrammatically a picture display apparatus with an equivalent circuit diagram of a portion of the electrophoretic display,

FIG. 6 shows drive voltages for updating a complete area of the display screen or the sub-area on the display screen in accordance with an embodiment of the invention,

FIG. 7 shows drive voltages for updating a complete area of the display screen or the sub-area on the display screen in accordance with an embodiment of the invention,

FIG. 8 shows a block diagram of a control circuit for driving the bi-stable display in accordance with an embodiment of the invention, and

FIG. 9 shows a block diagram of a drive circuit for driving the bi-stable display.

### DETAILED DESCRIPTION OF THE PREFERRED EMBODIMENT

In different Figures, the same references are used to indicate the same items.

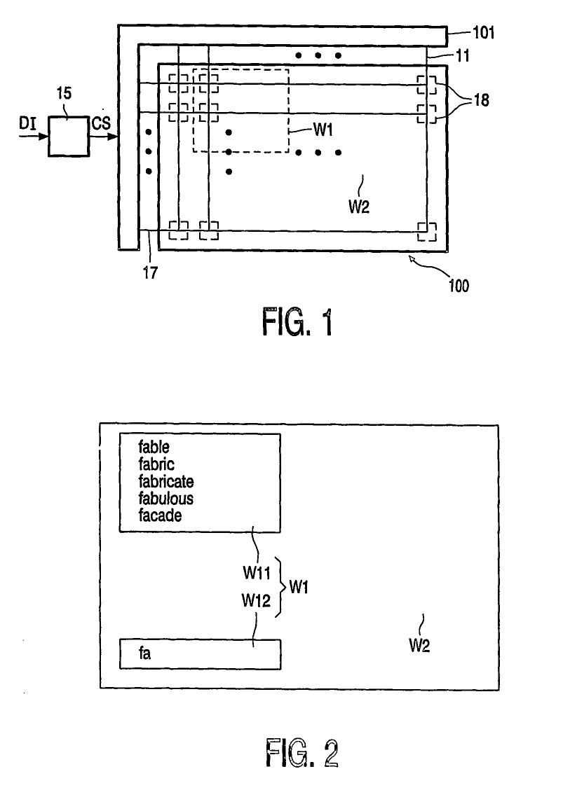

FIG. 1 shows schematically a display apparatus with a driver 101 and a bi-stable matrix display 100. The matrix display 100 comprises pixels 18 associated with intersections of the select electrodes 17 and data electrodes 11. Usually, the select electrodes 17 extend in the row direction and are also referred to as row electrodes and the data electrodes 11 extend in the column direction and are also referred to as column electrodes. Usually, the bi-stable matrix display 100 is an active matrix display which comprises transistors 19 (shown in FIG. 5, not shown in FIG. 1) which are controlled by select voltages on the select electrodes 17. A particular row of pixels 18 of which the control inputs are connected with a particular one of the select electrodes 17 is selected if the driver 101 (the select driver 16 of FIG. 5) supplies a select voltage to this particular one of the select electrodes 17 to obtain conductive transistors 19. The data voltages on the data electrodes 11 are supplied to this selected row of pixels 18 via the conductive transistors 19. The other rows of pixels 18 associated with the other select electrodes 17 are not selected if the driver 101 supplies select voltages to obtain non-conductive transistors 19. The data voltages on the data electrodes 11 are unable to influence the voltage across the pixels 18 of these non-selected rows of pixels 18 because the transistors 19 are non-conductive.

FIG. 1 indicates a first area W1 on the display screen of the matrix display 100 and a second area W2 on the display screen. By way of example only, the first area W1 is a rectangular window and the second area W2 comprises all the pixels 18 which are not within the window W1. The first area W1 is further referred to as sub-area W1 to indicate that the first area W1 is smaller than the complete display area of the display 100. The second area W2 may indicate the complete display area of the display 100, or the area of the display 100 outside the sub-area W1.

Usually, the optical state of the pixels 18 of the complete display 100 is updated during an image update period IUP. Usually, during an image update period IUP, the driver circuit 101 selects the rows of pixels 18 one by one. The driver circuit 101 further supplies drive waveforms to the pixels 18 of the selected row in parallel via the data electrodes 11.

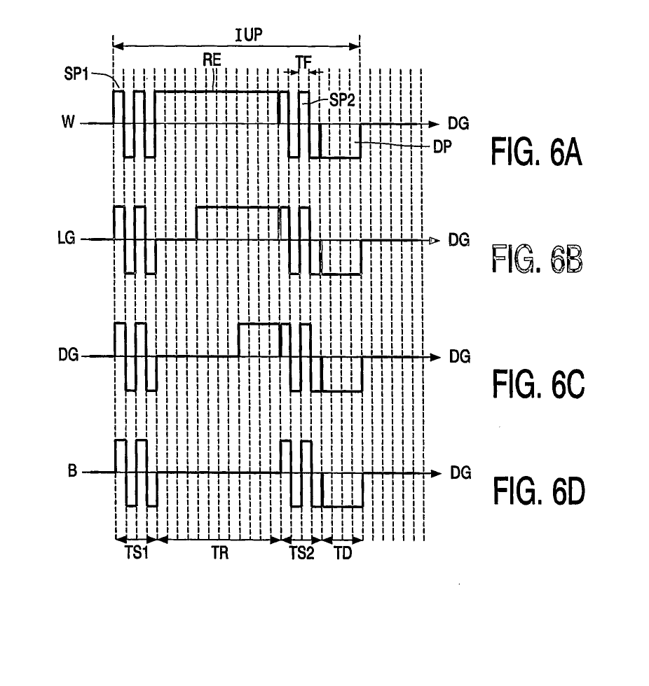

The drive waveform for a particular pixel 18 depends on the optical transition to be made by this pixel 18. This is illustrated for an electrophoretic display with respect to FIG. 6. Because usually all the pixels 18 of the display 100 have to be updated, and because the optical transition of each pixel 18 is arbitrary, the image update period IUP is determined by the longest image update period IUP. It has to be noted that the drive waveforms shown in FIG. 6 comprise a sequence of frame periods TF. During each frame period all the pixels 18 have to be updated (in fact, every pixel 18 receives a drive waveform required for obtaining the desired optical transition of the pixel 18). Thus, during each frame period TF, all the rows of pixels 18 have to be selected row by row and the driver 101 supplies the appropriate level of the drive voltage waveforms via the data electrodes 11 in parallel to each selected row of pixels 18. A row of pixels 18 should be selected during a minimal time to allow the capacitive pixels 18 to be charged sufficiently to the appropriate level. The duration of the frame period TF is determined by this minimal time and the number of rows which has to be selected. Thus, the duration of the drive waveform depends on the drive waveform required for a particular optical transition and on the duration of the frame period TF.

If only a group of the pixels 18 associated with a sub-area W1 of the display 101 has to be updated only the rows of pixels 18 associated with the sub-area W1 have to be selected during the image update period IUP. Because less then all the rows of pixels 18 have to be selected, the frame period TF will be shorter and thus the duration of a drive waveform will be shorter. It is thus possible to update the image within the sub-area W1 with an image update period IUP shorter than the image update period IUP required for the second area W2 wherein all the rows of pixels 18 have to be selected. Consequently, the refresh rate of the information displayed in the sub-area W1 is higher than the refresh rate of the information displayed in the second area W2.

The refresh rate for the sub-area W1 is optimally high if the dimension of the sub-area W1 is continually controlled based on which pixels 18 have to be updated. If is known or determined that only the pixels 18 in a sub-area of the sub-area W1 need to change their optical state, during a next image update period IUP, the sub-area W1 will get smaller dimensions to cover only the pixels 18 which need to change their optical state. Now, even less rows of pixels 18 have to be selected further decreasing the image update period IUP. The dynamic control of the dimensions of the sub-area W1 per image update period allows a maximum refresh rate of the information display in the sub-area W1.

A control circuit or processor 15 firstly processes incoming data DI into the data signals to be supplied by the column electrodes and supplies these data signals and timing signals as the control signals CS to control the drive circuit 101 to address the pixels 18. Depending of the display mode, the control circuit 15 provides control signals for addressing all the pixels 18 of the display or for addressing the pixels 18 of the sub-area W1 only.

The drive lines 12 carry signals which control the mutual synchronisation between the column driver 10 and the row driver 16.

FIG. 2 shows different areas on the display screen. The sub-area W1 now comprises two areas W11 and W12. The second area W2 covers the area of the display screen not covered by the first area W11, W12, or the total area of the display screen. The area W12 is a rectangular area showing a sequence of characters inputted by the user. In this example, the user inputted the string fa. The area W11 is a rectangular area showing a listing of words starting with the string fa. The area W2 shows background information, which is, for example, a comedy book page with grey pictures and text consisting the word “fabulous”, which is not known to the user. The user starts typing fa in W12 and more words starting with fa are listed in W11. The areas W11 and W12 need not be rectangular, but this will complicate the addressing of the pixels 18 of the areas.

It is important that the user gets a prompt reaction when he inputs the characters to be displayed in the window W12. In fact the user expects an immediate response on its typing action. However, the image update period IUP required for updating a complete electrophoretic display with 600 rows of pixels 18 is in the order of 0.6 to 1.1 seconds and thus far too long for an immediate response. But, if in response to a detected user input, only the information in the sub-area W12 is updated, only a few rows of pixels 18 need to be addressed during the image update period IUP and the image update period IUP will be sufficient short to reach a high refresh rate and thus a fast response on the input. If the user inputs more than one line, the dimensions of the window W12 in which the information has to be updated will be enlarged to cover the lines of input. Still, the refresh rate is relatively high, although lower than when only a single line of characters is inputted. If the user starts again with inputting new information, only a few characters are inputted and the dimensions of the window W12 are selected smaller to fit the new sub-area where the optical states of the pixels 18 have to change during the next image update period to obtain a maximum refresh rate. In the same manner, the dimensions of the window W11 wherein the information is displayed in response to the inputted characters are scaled with the actual amount of information. For example, if the 5 words shown are all words which should be displayed during a next image update period IUP, only the rows of pixels 18 associated with the sub-area W11 need to be addressed. If fewer words have to be displayed, the window W11 is smaller to cover the lower number of words to be displayed and the time required to update the information in the window W11 is smaller improving the reaction speed on the input of the user.

Thus, the controlling of the dimensions of the sub-area where the pixels 18 are updated based on the information on where during a next image update period IUP the optical states of pixels 18 should change, provides a maximum refresh rate for the actual information to be changed on the display 100. The other pixels 18 need not be addressed because in a bi-stable display, the information is kept for a relatively long period in time if no voltage is applied to the pixels 18. Such a driving scheme is impossible in displays which do not have the bi-stable behavior. These other displays are unable to display information for a relatively long period in time unchanged without updating the pixel voltages.

It is possible to fix a minimum dimension of the sub-area W1, for example for containing one inputted character. This is, for example, relevant if is known that the user input will contain at least one character. It is thus not required to check on individual pixels 18 whether one of the pixels 18 has to change its optical state. It might be checked how many characters are inputted by the user. If the starting position of the minimal sub-area is known, the sub-area which needs actually be updated can be determined from the number of characters or the number of words detected.

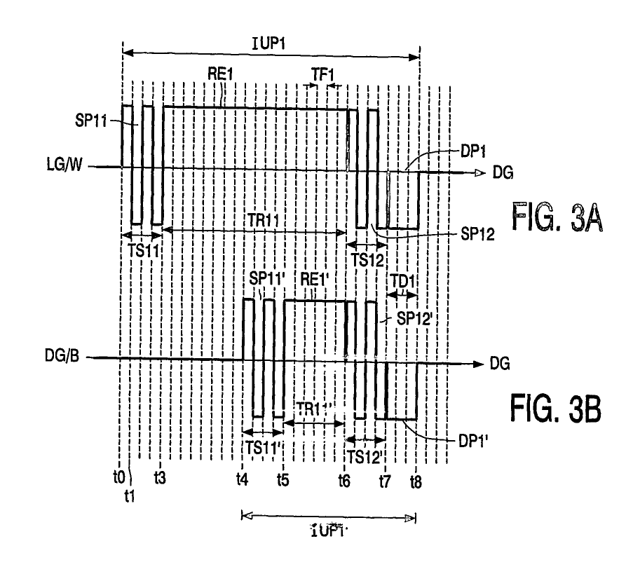

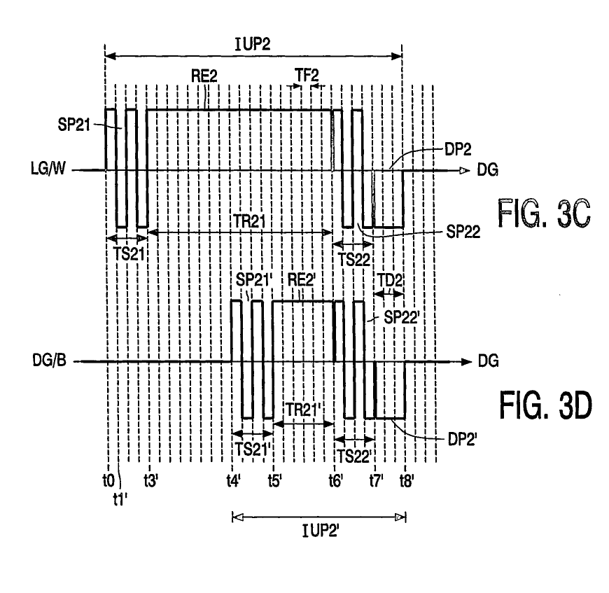

FIG. 3 shows drive voltage waveforms across a pixel in different situations wherein over-reset is used. By way of example, FIG. 3 are based on an electrophoretic display with black and white particles and four optical states: black B, dark grey DG, light grey LG, white W.

FIGS. 3A and 3B show different drive waveforms when all the rows of pixels 18 of the display 100 have to be selected to update the complete display area. FIGS. 3C and 3D show corresponding waveforms in the same time scale when only a subset of the rows of pixels 18 has to be selected to update the sub-area W1 of the display 100.

FIG. 3A shows an image update period IUP for a transition from light grey LG or white W to dark grey DG. FIG. 3B shows an image update period IUP for a transition from dark grey or black B to dark grey DG. The vertical dotted lines represent the frame periods TF (which usually last 20 milliseconds), the line periods occurring within the frame periods TF are not shown. Within one frame period TF all the rows of pixels 18 are selected, usually one by one.

In both FIG. 3A and FIG. 3B, the pixel voltage VD across a pixel 18 comprises successively first shaking pulses SP11, SP11′, a reset pulse RE1, RE1′, second shaking pulses SP12, SP12′ and a drive pulse DP1, DP1′. The drive pulses DP1, DP1′ occur during the same drive period TD1 which lasts from instant t7 to instant t8. The second shaking pulses SP12, SP12′ immediately precede the driving pulses DP1, DP1′ and thus occur during a same second shaking period TS12 lasting film instant t6 to t7. The reset pulse RE1, RE1′ immediately precede the second shaking pulses SP12, SP12′. However, due to the different duration TR11, TR11′ of the reset pulses RE1, RE1′, respectively, the starting instants t3 and t5 of the reset pulses RE1, RE1′, respectively are different. The first shaking pulses SP11, SP11′ which immediately precede the reset pulses RE1, RE1′, respectively, thus occur during different first shaking periods in time TS11, TS11′, respectively. The first shaking period TS11 lasts from instant t0 to instant t3, the first shaking period TS11′ lasts from instant t4 to instant t5.

In both FIG. 3C and FIG. 3D, the pixel voltage VD across a pixel 18 comprises successively first shaking pulses SP21, SP21′, a reset pulse RE2, RE2′, second shaking pulses SP22, SP22′ and a drive pulse DP2, DP2′. The drive pulses DP2, DP2′ occur during the same drive period TD2 which lasts from instant t7′ to instant t8′. The second shaking pulses SP22, SP22′ immediately precede the driving pulses DP2, DP2′ and thus occur during a same second shaking period TS22 lasting from instant t6′ to t7′. The reset pulse RE2, RE2′ immediately precede the second shaking pulses SP22, SP22′. However, due to the different duration TR21, TR21′ of the reset pulses RE2, RE2′, respectively, the starting instants t3′ and t5′ of the reset pulses RE2, RE2′, respectively are different. The first shaking pulses SP21, SP21′ which immediately precede the reset pulses RE2, RE2′, respectively, thus occur during different first shaking periods in time TS21, TS21′, respectively. The first shaking period TS21 lasts from instant t0′ to instant t3′, the first shaking period TS21′ lasts from instant t4′ to instant t5′.

Thus, the shape of the drive waveforms supplied to the pixels 18 when updating the complete display area, or when updating only the sub-area W1 is the same for the same optical transitions. However, the time required to update these different areas is different. The frame period TF1 lasts longer than the frame period TF2. During each frame period TF1 all the lines of the display 100 have to be addressed to be able to provide the drive waveforms to all the pixels 18 of the display 100. During the frame period TF2, only the lines of the sub-area W1 have to be addressed.

Because, in this drive scheme different pixels 18 may have to perform different optical transitions, and different drive waveforms are required to obtain these different optical transitions, the pixels 18 should be separately addressable. Both outside the sub-area W1 different waveforms are required as shown in FIGS. 3A and 3B, and within the sub-area W1 different waveforms are required as shown in FIGS. 3C and 3D. The pixels 18 are separately addressable if the select electrodes 17 are selected one by one. In this driving scheme, the shaking pulse outside the sub-area W1 (SP11, SP12 in FIG. 3A), and/or the shaking pulse within the sub-area W1 (SP21, SP22 in FIG. 3C) are not supplied to the pixels (18) both outside and within the sub-area W1, which do not have to change their optical state. For these last mentioned pixels, also no other voltage pulses are supplied which are able to influence an optical state of the pixel (18). For example, if the current optical state is dark grey DG and the subsequent image requires the optical state of the same pixel 18 to be also dark grey DG, no update is needed and a hold voltage should be supplied to this pixel 18, i.e. intentionally no image changeable drive waveform is supplied during this image update period. Usually, the hold voltage is substantially zero.

However, in another drive scheme, it is possible to provide parts of the drive waveforms which are equal for all pixels 18 to all the selected pixels 18. It is even possible to select subgroups of the select electrodes 17 or all the select electrodes 17 at the same time to supply the same voltages to all the selected pixels 18. For example, this would be possible during the shaking pulse SP12 and SP12′ outside the sub-area W1, and during the shaking pulses SP22 and SP22′ within the sub-area W1. If the shaking pulses SP11 and SP11′, and the shaking pulse SP21 and SP21′ are aligned also (see FIG. 6) it is possible to provide the same voltages to the selected pixels 18 during these shaking pulses.

If however it is desired to supply besides the drive waveforms shown in FIGS. 3C and 3D a hold voltage to the pixels 18 within the sub-area W1 which should not change their optical state, it is not possible to supply the time aligned shaking pulse to all the pixels 18 of the sub-area.

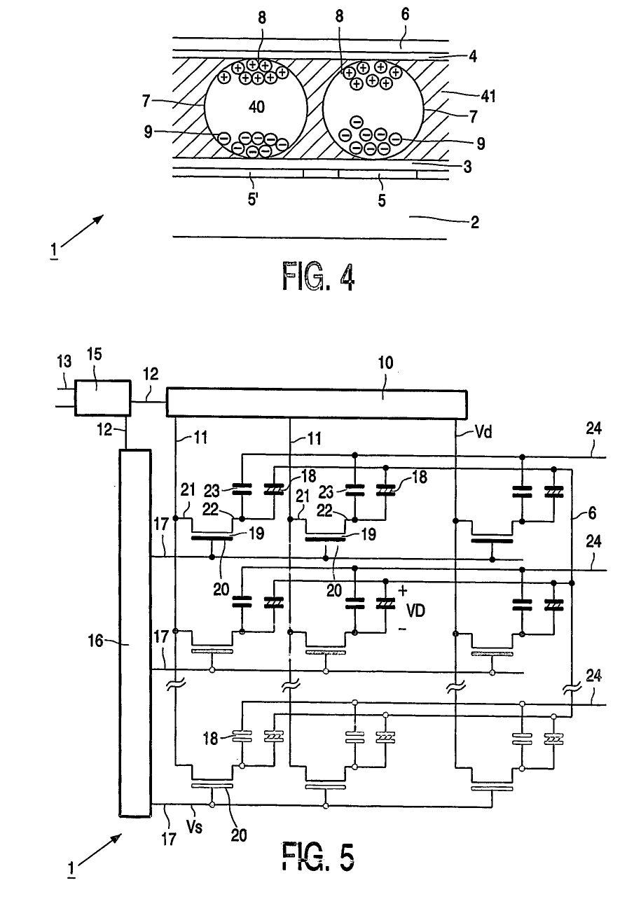

FIG. 4 shows diagrammatically a cross-section of a portion of an electrophoretic display, which for example, to increase clarity, has the size of a few display elements only. The electrophoretic display comprises a base substrate 2, an electrophoretic film with an electronic ink which is present between two transparent substrates 3 and 4 which, for example, are of polyethylene. One of the substrates 3 is provided with transparent pixel electrodes 5, 5′ and the other substrate 4 with a transparent counter electrode 6. The counter electrode 6 may also be segmented. The electronic ink comprises multiple microcapsules 7 of about 10 to 50 microns. Each microcapsule 7 comprises positively charged white particles 8 and negatively charged black particles 9 suspended in a fluid 40. The dashed material 41 is a polymer binder. The layer 3 is not necessary, or could be a glue layer. When the pixel voltage VD across the pixel 18 (see FIG. 5) is supplied as a positive drive voltage to the pixel electrodes 5, 5′ with respect to the counter electrode 6, an electric field is generated which moves the white particles 8 to the side of the microcapsule 7 directed to the counter electrode 6 and the display element will appear white to a viewer. Simultaneously, the black particles 9 move to the opposite side of the microcapsule 7 where they are hidden from the viewer. By applying a negative drive voltage between the pixel electrodes 5, 5′ and the counter electrode 6, the black particles 9 move to the side of the microcapsule 7 directed to the counter electrode 6, and the display element will appear dark to a viewer (not shown). When the electric field is removed, the particles 8, 9 remain in the acquired state and thus the display exhibits a bi-stable character and consumes substantially no power. Electrophoretic media are known per se from e.g. U.S. Pat. No. 5,961,804, U.S. Pat. No. 6,1120,839 and U.S. Pat. No. 6,130,774 and may be obtained from E-ink Corporation.

FIG. 5 shows diagrammatically a picture display apparatus with an equivalent circuit diagram of a portion of the electrophoretic display. The picture display device 1 comprises an electrophoretic film laminated on the base substrate 2 provided with active switching elements 19, a row driver 16 and a column driver 10. Preferably, the counter electrode 6 is provided on the film comprising the encapsulated electrophoretic ink, but, the counter electrode 6 could be alternatively provided on a base substrate if a display operates based on using in-plane electric fields. Usually, the active switching elements 19 are thin-film transistors TFT. The display device 1 comprises a matrix of display elements associated with intersections of row or select electrodes 17 and column or data electrodes 11. The row driver 16 consecutively selects the row electrodes 17, while the column driver 10 provides data signals Vd in parallel to the column electrodes 11 to the pixels 18 associated with the selected row electrode 17. Preferably, a processor 15 firstly processes incoming data 13 into the data signals to be supplied by the column electrodes 11.

The drive lines 12 carry signals which control the mutual synchronisation between the column driver 10 and the row driver 16.

The row driver 16 supplies an appropriate select pulse Vs to the gates of the TFT's 19 which are connected to the particular row electrode 17 to obtain a low impedance main current path of the associated TFT's 19. The gates of the TFT's 19 which are connected to the other row electrodes 17 receive a voltage Vs such that their main current paths have a high impedance. The low impedance between the source electrodes 21 and the drain electrodes of the TFT's allows the data voltages Vd present at the column electrodes 11 to be supplied to the drain electrodes which are connected to the pixel electrodes 22 of the pixels 18. In this manner, a data signal Vd present at the column electrode 11 is transferred to the pixel electrode 22 of the pixel or display element 18 coupled to the drain electrode of the TFT if the TFT is selected by an appropriate level Vs on its gate. In the embodiment shown, the display device of FIG. 1 also comprises an additional capacitor 23 at the location of each display element 18. This additional capacitor 22 is connected between the pixel electrode 22 and one or more storage capacitor lines 24. Instead of TFTs, other switching elements can be used, such as diodes, MIMs, etc.

The other electrodes of the pixels 18 are connected to a common electrode 6. The voltage VD between the pixel electrodes 5, 5′ and the common electrode 6 determine the optical state of the pixels 18.

FIG. 6 shows drive voltages for updating a complete area of the display screen or the sub-area on the display screen in accordance with an embodiment of the invention. FIG. 6A shows a drive waveform for an optical transition from white W to dark grey DG. FIG. 6B shows a drive waveform for an optical transition from light grey LG to dark grey DG. FIG. 6C shows a drive waveform to keep the optical state dark grey DG. FIG. 6D shows a drive waveform for an optical transition from black B to dark grey DG. For other transitions similar drive waveforms are required. For example, for the transition from white W to black B, portions of the waveform of FIG. 6A can be used, but with DP=0V.

FIG. 6 show drive waveforms for all optical transitions to dark grey DG if the drive voltages VD across a pixel 18 comprise shaking periods SP1, SP2 which occur during the same time periods and no over-reset is used. Alternatively, over-reset may be used, or drive voltage waveforms may be used in which the end of the first shaking pulses SP1 and the start of the reset pulses RE substantially coincide. In the latter case, the duration of the image update period IUP will be dependent on the optical transition and it will not be possible to align both the shaking pulses SP1 and the shaking pulses SP2 in drive waveforms for different optical state transitions. The drive waveforms for optical transitions other than to dark grey DG have a similar build up.

The use of both a shaking pulse SP1 preceding the reset pulse RE and a shaking pulse SP2 in-between the reset pulse RE and the drive pulse DP improves the reproducibility of grayscales. The grayscales will be less influenced by the history of the drive voltage. The alignment of the shaking pulses SP1 and SP2 such that they occur at the same time during each image update period IUP independent on the optical transition required, has the advantage that the power efficiency increases. This, because it is possible, for each preset pulse of the shaking pulse SP1, SP2 to select all the lines of pixels 18 simultaneously and to supply the same data signal level to all the pixels 18. The effect of capacitances between pixels 18 and electrodes 11, 17 will decrease. Further, as all the pixels 18 may be selected simultaneously, the duration of the preset pulses of the shaking pulse SP1, SP2 may become much shorter than the standard frame period TF thus shortening the image update period IUP. This is disclosed in more detail in the non-prepublished patent application PHNL030524 which has been filed as European patent application.

In all FIG. 6, the first shaking pulses SP1 occur during the same first shaking period TS1, the second shaking pulses SP2 occur during the same second shaking period TS2, and the drive pulse DP occurs during the same drive period TD. The drive pulses DP may have different durations. The reset pulse RE has a length which depends on the optical transition of the pixel 18. For example, in a pulse width modulated driving, the full reset pulse width TR is required for resetting the pixels 18 from white W to black B or white W to dark grey DG, see FIG. 6A. For resetting the pixels 18 from light grey LG to black B or from light grey LG to dark grey DG, only ⅔ of the duration of this full reset pulse width TR is required, see FIG. 6B. For resetting the pixels 18 from dark grey DG to black B or to dark grey DG, only ⅓ of the duration of this full reset pulse width TR is required, see FIG. 6C. For resetting the pixels 18 from black B to dark grey DG, no reset pulse RE is required, see FIG. 6D.

These waveforms are also useful when the known transition matrix based driving methods are used in which previous images are considered in determining the impulses (time×voltage) for a next image. Alternatively, these waveforms are also useful when the electrophoretic material used in the display is less sensitive to the image history and/or dwell time.

Thus, to conclude, independent of the duration of the reset pulse RE, the first shaking pulses SP1 and the second shaking pulses SP2 can be supplied to all the pixels 18 simultaneously.

It has to be noted that in such a display which is able to display the optical states black B, dark grey DG, light grey LG and white W, the image update period IUP has always the same duration. However, in such a display apparatus which is optimized to display accurate grey levels the image update period IUP is relatively long. An embodiment of the present invention is based on the insight that if on a particular sub-area W11, W12 of the display screen information is displayed for which it is not required to use all the available optical states it is possible to select states which require a shorter image update period IUP.

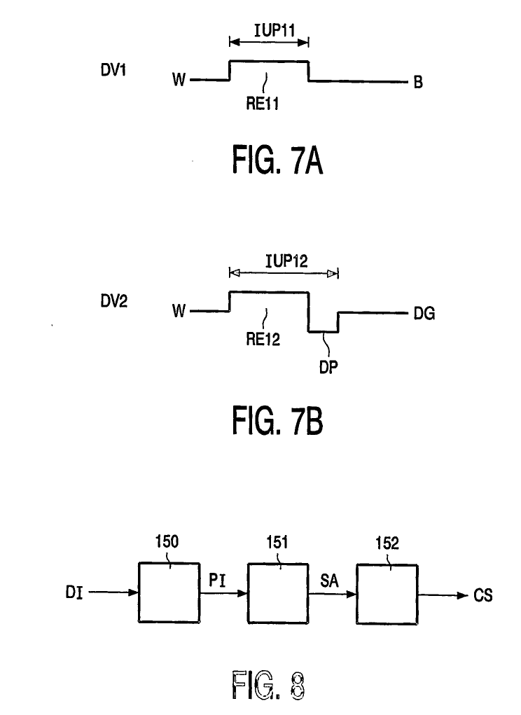

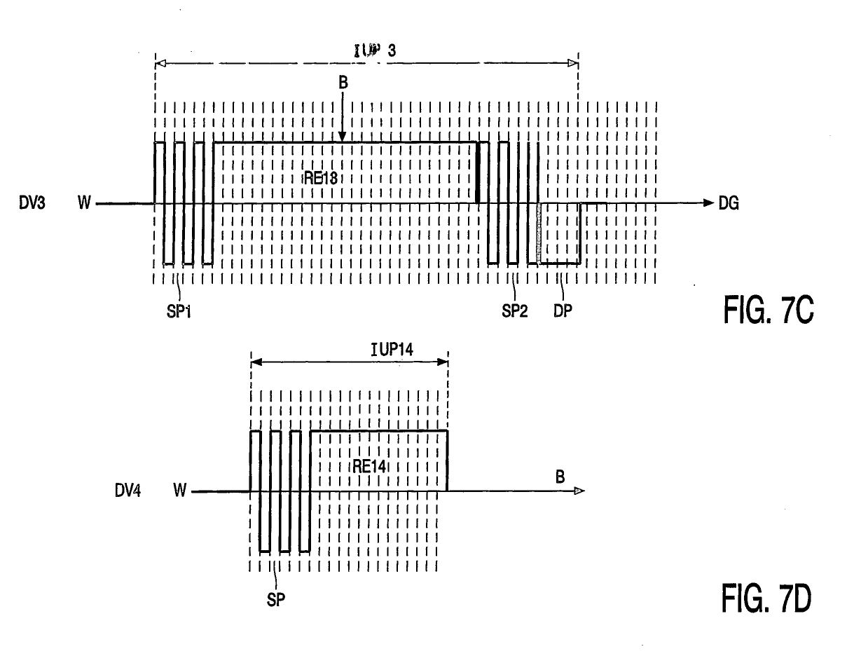

For example, if still a high accuracy of the optical states in the sub-area W11, W12 is required, preferably, only the extreme optical states, for example black B and white W are selected. In the sub-area W11, W12 now the drive voltage waveform DV1 shown in FIG. 7A may be used. For image updates in the area W2 the much longer lasting voltage waveforms shown in FIG. 7C are used to be able to display intermediate optical states with a high accuracy.

FIG. 6A shows the same drive waveform as shown in FIG. 3A if the frame period TF is equal to the frame period TF1 of FIG. 3A. FIG. 6A shows the same drive waveform as shown in FIG. 3C if the frame period TF is equal to the frame period TF2 of FIG. 3C. FIG. 6C shows the drive waveform as shown in FIG. 3B if the frame period TF is equal to the frame period TF1 of FIG. 3A and if the second shaking pulses SP2 are aligned in time. FIG. 6C shows the same drive waveform as shown in FIG. 3D if the frame period TF is equal to the frame period TF1 of FIG. 3A and if the second shaking pulses are aligned in time. FIGS. 6B and 6D show additional drive waveforms for other optical transitions.

Now, both the first and the second shaking pulses SP2 occur for every pixel 18 during a same second shaking period TS1, TS2, respectively. This will cause a lower power consumption if the usual row at a time select addressing is applied. If the complete display is addressed, and all the rows of pixels 18 are selected one by one, during the first shaking period TS1 and during the second shaking period TS2, always the same voltage level is applied during the complete frame period TF. Consequently, the parasitic capacitances in the display, for example between pixels or between electrodes will have no influence. The same is true if only the rows of the sub-area W1 are selected one by one. Although now the gain in power consumption will be less as the frame periods TF1 are shorter than the frame periods TF2.

But, alternatively, the alignment of the shaking pulses SP1, SP2 enables to select the duration of the shaking period TS1, TS2 much shorter as shown in FIG. 6. For clarity, each one of levels of the second shaking pulses SP1, SP2 is present during a frame period TF1, TF2. In fact, now, during the shaking periods TS1, TS2, the same voltage levels can be supplied to all the pixels 18 during each frame period TF1, TF2. Thus, instead of selecting the pixels 18 line by line, it is now possible to select all the pixels 18 at once, and only a single line select period TL instead of a frame period suffices per level. Thus, the shaking periods TS1, TS2 only need to last four line periods TL instead of four frame periods TF1 or TF2, respectively.

Alternatively it is possible to select groups of rows of pixels 18 at the same time during the shaking periods SP1, SP2. This lowers the power consumption and decreases the frame period TF1, TF2 during the shaking periods TS1, TS2.

The driving pulses DP are shown to have a constant duration, however, the drive pulses DP may have a variable duration.

If the drive method shown in FIG. 6 is applied outside the shaking periods TS1, TS2, the pixels 18 have to be selected row by row by activating the switches 19 line by line with the select electrodes 17. The voltages VD across the pixels 18 of the selected line are supplied via the column electrodes 11 in accordance with the optical state the pixel 18 should have. For example, for a pixel 18 in a selected row of which pixel 18 the optical state has to change from white W to dark grey DG, a positive voltage has to be supplied at the associated column electrode 11 during the frame period TF1, TF2 starting at instant t0. For a pixel 18 in the selected row of which pixel 18 the optical state has to change from black B to dark grey DG, a zero voltage has to be supplied at the associated column electrode during the frame period TF1, TF2 lasting from instants t0 to t1.

To conclude, the same drive waveforms may be used for updating the image of the total display W2 or for updating the image in the sub-area W1 only. The frame periods TF2 will be shorter than the frame periods TF1 because less rows of pixels 18 have to be selected during the updating of the sub-area W1 only than during the updating of the complete display area W2. Consequently, the image update period for the sub-area W1 will be shorter than for the complete display area W2. The image update period of the sub-area W1 will be optimally short if the dimensions of the sub-area are dynamically controlled to be as small as possible to cover only the pixels 18 which should change their optical state.

During the aligned shaking pulses SP1 and SP2, the rows of pixels 18 can be selected in groups at a time. The frame periods TF1, TF2 during the aligned shaking pulses SP1 and SP2 will be shorter than for the pulses in the drive waveform which may differ for different pixels 18. Thus, the alignment of the shaking pulses SP1, SP2 if applied in the display area W2 increases the refresh rate for the display area W2. The alignment of the shaking pulses SP1, SP2 if applied to the sub-area W1 further decreases the image update period for the sub-area W1.

FIG. 7 shows drive voltages used for updating the first or the second area on the display screen in accordance with an embodiment of the invention.

If only a group of the pixels 18 associated with a first area or sub-area W1 of the display 101 has to be updated and the information to be displayed in this sub-area W1 does not use optical transitions which require the longest image update period IUP, it is possible to update the image within the sub-area W1 with an image update period IUP shorter than the longest image update period IUP. Consequently, the refresh rate of the information displayed in the sub-area W1 is higher than would be possible if the longest image update period IUP was used.

By way of example, the information in the areas or windows W11 and W12 is displayed in black and white which are the extreme optical states of the display device 101. The duration of the drive waveforms required to change the optical state of the pixels 18 to black B or white W is relatively short. The information in the area W2 is displayed with grey scales. The grey scales usually include the two extreme optical states black and white and at least one intermediate (grey) state. The drive waveforms required to change the optical state of a pixel 18 to a grey state is relatively long.

FIG. 7A shows a drive voltage waveform DV1 required to change the optical state of a pixel 18 from substantially white W to substantially black B. The drive voltage waveform DV1 comprises a reset pulse RE11. The reset pulse RE11 may have a duration just sufficient to guarantee that, at the end of the reset pulse RE11, the pixel 18 is in the extreme optical state black B. The reset pulse RE11 may have a longer duration than this minimally required duration to obtain an over-reset. If the drive waveform DV1 consists of the reset pulse RE11 only, the image update period IUP11 is relatively short.

FIG. 7B shows a drive voltage waveform DV2 required to change the optical state of a pixel 18 from substantially white W to an intermediate state dark grey DG. This drive voltage waveform DV2 comprises a reset pulse RE12 preceding a drive pulse DP. The reset pulse RE12 may be equal to the reset pulse RE11 and changes the optical state of the pixel 18 into substantially black B. The drive pulse DP changes the optical state from the well defined substantially black B to dark grey DG. As the drive waveform DV2 now comprises the reset pulse RE12 and additionally a drive pulse DP, the duration of the image update period IUP12 is relatively long.

If in the area W2 of the display screen the optical states of the pixels 18 should be able to change both from substantially white W to substantially black B, and from substantially white W to dark grey DG, the image update period IUP during the second display mode is determined by the drive voltage waveform DV1, DV2 with the longest duration. Thus the image update period will be IUP12 which has the duration of the reset pulse RE12 and the drive pulse DP together.

If in the sub-areas W11 and W12 of the display screen the optical states of the pixels 18 only need to change to substantially black B, the image update period IUP during the first display mode is determined by the drive voltage waveform DV1. Thus the image update period will be IUP11 which has the duration of the reset pulse RE1 only.

Consequently, if only the image in the areas W11 and W12 is refreshed the image update period is IUP1 which is shorter than the image update period IUP2 required in the area W2. It is thus possible to refresh the information in the areas W11 and W12 at a relatively high rate with respect to the refresh rate of the information in the area W2. In the application shown by way of example in FIG. 2, it is better possible to keep track with the input of the user. Thus in combination with only updating the information in the sub-area W1 with dynamically controlled minimal dimensions, the use of only optical states in the sub-area which require short drive waveforms DV1 provides a maximum refresh rate.

Usually, the drive voltage waveform DV2 required to reach an intermediate grey level with high accuracy is more complex than shown in FIG. 7B. Such drive voltage waveforms DV3 and DV4 are shown for an electrophoretic display in FIGS. 7C and 7D. Especially if these complex waveforms are used to obtain intermediate grey levels (or more general: intermediate optical states in a color display) during the second display mode wherein the complete display area W2 is updated, the image update period may become significantly shorter if only the two extreme optical states are used during the first display mode wherein only the sub-area W1 is updated.

FIG. 7C shows a complex drive waveform for obtaining an optical transition from white W to dark grey DG. The drive waveform comprises successively first shaking pulses SP1, a reset pulse RE13, second shaking pulses SP2, and a drive pulse DP. This drive waveform is identical to the waveform shown in FIG. 3A or 3C depending on whether it is used during the first display mode or during the second display mode. The vertical arrow indicated by B indicates the instant when the optical state black B is reached. The part of the reset pulse RE13 to the right hand side of this arrow indicates the over-reset. The total duration of this waveform DV3 is IUP13. FIG. 7D shows a drive waveform for obtaining an optical transition form white W to black B. The drive waveform comprises successively a shaking pulse SP and a reset pulse RE14. The total duration of this waveform DV4 is IUP14.

It is also possible to use another subset of the optical state transitions than the two extreme optical states to decrease the image update period for information which may be displayed with such a subset of the optical state transitions. What is relevant is that the duration of the drive voltage waveforms DV1 required for the subset of the optical state transitions which have to occur within the sub-area W11, W12 have a duration which is shorter than the duration required for the drive voltage waveform DV2 for an optical state transition not in the subset and which optical state may occur within the second area W2.

It is assumed that all optical states (black B, dark grey DG, light grey LG, white W) may occur during the second display mode when the optical states of the pixels 18 in the second area W2 are updated. Consequently, the image update period IUP2 during the second display mode is determined by the drive voltage waveform with the longest duration. The drive voltage waveform with the longest duration is shown in FIG. 7C.

If during the first display mode when the optical state of the pixels 18 in the sub-area W1 are updated it is not required to be able to make the transition from white W to dark grey DG, the image update period IUP will not be determined by the relatively long image update period IUP shown in FIG. 7C. For example, if only the optical states black B and dark grey are used in the sub-area W1, the image update period will be determined by the duration IUP′ of the drive waveform shown in FIG. 7D or of FIG. 7A in which the frame period TF is equal to the frame period TF2. The duration of this drive waveform is much shorter than the duration IUP1 of the drive voltage waveform shown in FIG. 7C or in FIG. 3A. Consequently, the refresh rate of the information displayed in the first area W1 is further increased with respect to the refresh rate of the information displayed in the second area W2.

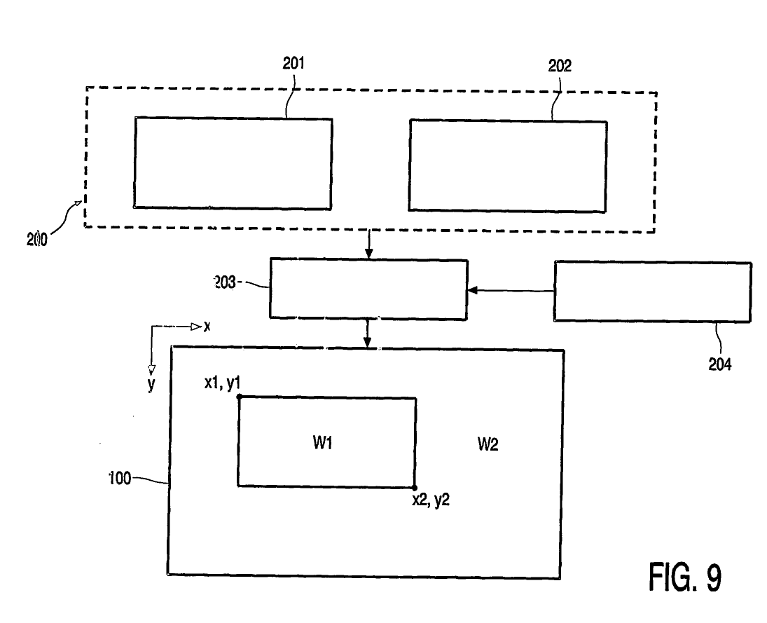

FIG. 8 shows a block diagram of a control circuit for driving the bi-stable display in accordance with an embodiment of the invention. The control circuit 15 comprises an optional optical state change detector 150 which receives the input information to be displayed, also referred to as incoming data DI, to determine which pixels 18 have to change their optical state during a next image update period IUP. An area determining circuit 151 dynamically determines the dimensions of the sub-area to cover the pixels W1 which have to be updated during this image update period IUP. The output signal SA of the area determining circuit 151 indicates the sub-area W1, for example by supplying coordinates. An addressing controller 152 supplies control signals CS to control the drive circuit 101 to only address the pixels 18 of the sub-area W1. The controller 15 may comprise hardware circuits or a suitably programmed processor.

The change state detector 150 may operate in many known ways. For example, the change state detector 150 may comprise a memory to store the previous image to be displayed. The present image to be displayed is compared with the stored image to determine which pixels have to change their optical state.

The area determining circuit 151 receives from the change state detector 150 information PI on which pixels 18 have to change their optical state to determine the dimensions of the sub-area W1 of pixels 18 which has to be addressed during the next image update period. Preferably, the dimensions of the sub-area W1 are selected minimally to just cover the pixels 18 which have to change their optical state. However, preferably, the sub-area is selected to be a rectangular area because a rectangular area is easy to address in a matrix display. The rectangular area is selected to cover all the pixels 18 which have to be updated. Thus within the rectangular area, pixels 18 may occur which need not be updated. But, anyhow, the dimensions of the rectangular area are selected as small as possible to just cover the pixels 18 which should alter their optical state. Alternatively, the area determining circuit 151 may receive input (PI), for example the coordinates of opposing corners of a rectangular window, indicating in which area the user inputs information which has to be refreshed.

FIG. 9 shows a block diagram of a drive circuit for driving the bi-stable display. The controller/driver 203 receives information on grayscale drive voltage waveforms 201 and the black and white drive voltage waveforms 202 as stored in a table look up memory 200. The controller/driver 203 further receives the coordinates x1, y1 and x2, y2 of two opposing corners of the sub-area or window W1 on the display screen of the display device 100. The window W1 is also referred to as the first area, the second area W2 comprises the pixels not within the first area W1.

In the first display mode when only the pixels 18 of the first area W1 are updated, the controller/driver 203 selects the rows of pixels 18 within the first area W1 one by one while the black and white drive voltage waveforms 202 are supplied via the column electrodes 11 to the pixels 18 within the first area W1 only to prevent a change of the optical state of pixels 18 outside the first area W1.

In the second display mode when only the pixels 18 of the second area W2 are updated, the controller/driver 203 selects the rows of pixels 18 within the second area W2 one by one while the grayscale drive voltage waveforms 201 are supplied via the column electrodes 11 to the pixels 18 within the second area W2 only to prevent a change of the optical state of pixels 18 outside the second area W2.

In the example shown in FIG. 9, during the first display mode the rows of pixels between the vertical coordinates y1 and y2 are selected, while during the second display mode all the rows have to be selected.

It is also possible to use the same waveforms in both the first and the second area W1, W2. It is than not required to store both the different black and white and grey scale waveforms.

It should be noted that the above-mentioned embodiments illustrate rather than limit the invention, and that those skilled in the art will be able to design many alternative embodiments without departing from the scope of the appended claims. Although, the embodiments are illustrated in more detail with respect to electrophoretic displays, the same approach may be valid for other bi-stable displays.

In the embodiments described with respect to the figures, drive waveforms with pulse-width modulation (PWM) are used. The intermediate optical state is achieved by varying the drive pulse time. This invention is also applicable when other driving methods are used, for example, based on voltage modulated driving, i.e. the intermediate optical state is achieved by varying the voltage level of the drive pulse.

It is also possible to use drive schemes in which the reset pulse is absent.

The invention is also applicable to multi color displays, for example, electrophoretic displays in which three differently colored particles are present.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A driver for driving a bi-stable display (100), the driver comprises
a drive circuit (101) for supplying voltage waveforms to pixels (18) of said display (100), and a controller (15) for receiving information to be displayed (DI) on the display (100) during an image update period (IUP), the controller (15) comprises:
means for determining (151) a sub-area of pixels (W1) to be updated during this image update period (IUP), dimensions of the sub-area (W1) being dynamically changed to cover pixels (18) which have to change their optical state during this image update period (IUP), and
an address controller (152) for controlling the drive circuit (101) to only address the pixels (18) of the sub-area (W1).

2. A driver as claimed in claim 1, wherein the controller (15) further comprises means for determining (150) which pixels (18) have to change their optical state during this image update period (IUP).

3. A driver as claimed in claim 1, wherein the bi-stable display (100) is a matrix display comprising intersecting select electrodes (17) and data electrodes (11) for obtaining intersections, the pixels (18) being associated with the intersections, the drive circuit (101) comprising
a select driver (16) for supplying select voltages (Vs) to the select electrodes (17) to select at least one line of pixels (18) extending in the direction of the select electrodes (17), and
a data driver (10) for supplying data voltages (Vd) to the data electrodes (11) to determine an optical state of the at least one line of pixels (18) being selected, and wherein
the address controller (152) is arranged for controlling:
the select driver (16) to select only the lines of pixels (18) associated with the sub-area (W1), and
the data driver (10) to supply a hold-voltage to pixels (18) which are not associated with the sub-area (W1), the hold-voltage being selected to substantially not influence an optical state of the pixels (18) being selected.

4. A driver as claimed in claim 3, wherein the address controller (152) is arranged for also supplying the hold-voltage to pixels (18) within the sub-area (W1) which do not have to change their optical state.

5. A driver as claimed in claim 3, wherein the sub-area (W1) is a rectangular window, and wherein the address controller (152) for controlling the drive circuit (101) to only address the pixels (18) of the sub-area (W1) is arranged for controlling the select driver (16) to select, during the image update period (IUP), only the select electrodes (17) of a group of consecutive select electrodes associated with the sub-area (W1).

6. A drive circuit (101) as claimed in claim 5, wherein the controller (15) is arranged to receive at least coordinates (x1, y1, x2, y2) of two opposite corners of the rectangular window (W1) to determine the select electrodes (17) and the data electrodes (11) being associated with the sub-area (W1).

7. A driver as claimed in claim 1, wherein the controller (15) is arranged for determining substantially minimal dimensions of the sub-area (W1).

8. A driver as claimed in claim 3 wherein, during the image update period (IUP), the controller (15) is arranged for controlling the select driver (16) to select the select electrodes (17) associated with the sub-area (W1) one by one.

9. A driver as claimed in claim 3, wherein the bi-stable matrix display (100) is an electrophoretic matrix display comprising microcapsules (7) with at least two types of different particles (8, 9) being oppositely charged and having a first and a second color, respectively, and wherein the controller (15) is arranged for
controlling the data driver (10) to supply, during the image update period (IUP), drive waveforms (DVi) comprising shaking pulses (SP) and drive pulses (Vdr) succeeding the shaking pulses (SP), the shaking pulses (SP) being aligned in time, and
controlling the select driver (16) to select the select electrodes (17) associated with the sub-area (W1) one by one during the drive pulses (Vdr) and in sub-groups during the shaking pulses (SP), the shaking pulse (SP) comprising at least one preset pulse having an energy sufficient to release the particles (8, 9) present in one of its limit positions corresponding to one of extreme optical states but insufficient to enable said particles (8, 9) to reach the other one of its limit positions corresponding another one of the extreme optical states.

10. A driver as claimed in claim 1, wherein the controller (15) is arranged for controlling, in a further display mode during a further image update period (IUP2), the drive circuit (101) to update a complete display area (W2) or an area (W2) outside the sub-area (W1).

11. A driver as claimed in claim 10, wherein the controller (15) is arranged for controlling, in the further display mode to select the pixels of the complete display area (W2) or the area (W2) outside the sub-area (W1) line by line, to address the pixels individually during an image update period (IUP).

12. A driver as claimed in claim 10, wherein the bi-stable matrix display (100) is an electrophoretic matrix display comprising microcapsules (7) with at least two types of different particles (8, 9) being oppositely charged and having a first and a second color, respectively, and wherein the controller (15) is arranged for controlling the data driver (10) to supply, during the further image update period (IUP2), drive waveforms (DVi) comprising shaking pulses (SP) and drive pulses (Vdr) succeeding the shaking pulses (SP), the shaking pulses (SP) being aligned in time, and for controlling the select driver (16) to select the select electrodes (17) associated with the complete display area (W2) or the area (W2) outside the sub-area (W1) one by one during the drive pulses (Vdr) and in sub-groups during the shaking pulses (SP).

13. A driver as claimed in claim 10, wherein the controller (15) is arranged to control the data driver (10) to supply, in a first display mode, first drive waveforms (VD1) to the pixels of the sub-area (W1) during the first mentioned image update period (IUP1), and in the further display mode, second drive waveforms (VD2) to the complete display area or the area outside the sub-area (W1) during the further image update period (IUP2), possible optical transitions in the first display mode and in the further display mode being selected to obtain a duration of the first mentioned image update period (IUP1) being shorter than the further image update period (IUP2).

14. A drive circuit (101) as claimed in claim 13, wherein
in the first display mode, the drive circuit (101) is arranged for generating during the first mentioned image update periods (IUP1) the first drive voltage waveforms (DV1) to obtain two extreme optical states only.

15. A drive circuit (101) as claimed in claim 13, wherein in a second display mode, the drive circuit (101) is arranged for generating during the further image update periods (IUP2) the second drive voltage waveforms (DV2) to display an image having at least one optical state in-between the two extreme optical states.

16. A display apparatus comprising a bi-stable display (100) and a driver as claimed in claim 1.

17. A display apparatus as claimed in claim 16, wherein the bi-stable matrix display (100) is an electrophoretic matrix display, in which at least one charged particle moves in a fluid upon application of external electric field.

18. A display apparatus as claimed in claim 17, wherein the electrophoretic matrix display (100) comprises microcapsules (7) with at least two types of different particles (8, 9), being oppositely charged and having a first and a second color, respectively.

19. A method of driving a bi-stable display (100) comprising:
supplying (101) voltage waveforms to pixels (18) of said display (100),
determining (151) a sub-area of pixels (W1) which has to be updated during this image update period (IUP), dimensions of the sub-area (W1) being dynamically determined to cover the pixels (18) which have to change their optical state during this image update period (IUP), and
controlling (152) the supplying (101) to only address the pixels (18) of the sub-area (W1).

20. A method of driving a bi-stable display (100) as claimed in claim 19, further comprising determining (150), based on information to be displayed (DI) on the display (100) during an image update period (IUP), which pixels (18) have to change their optical state during the image update period (IUP).
